(19) United States
(12) Patent Application Publication
(10) Pub. No.: US 2015/0225525 A1
(43) Pub. Date: Aug. 13, 2015

(54) ANTIMICROBIAL ION-IMPREGNATED IONOMERS

(71) Applicant: E. I. DU PONT DE NEMOURS AND COMPANY, Wilmington, DE (US)

(72) Inventor: SAM LOUIS SAMUELS, LANDENBERG, PA (US)

(21) Appl. No.: 14/689,497

(22) Filed: Apr. 17, 2015

Related U.S. Application Data
(63) Continuation of application No. 11/640,613, filed on Dec. 18, 2006, now abandoned.
(60) Provisional application No. 60/750,889, filed on Dec. 16, 2005.

(51) Int. Cl. C08J 7/14; D06M 11/83; D06M 16/00

(52) U.S. Cl. CPC C08J 7/14; D06M 16/00; D06M 11/83; C08J 2323/08; D06M 2101/26

(57) ABSTRACT

Disclosed are fabrics and shaped articles, such as molded articles including containers and closures, tubing, films and sheets comprising ionomers that have been impregnated with antimicrobial ions such as silver or copper ions by ion exchange. The articles and fabrics have effective antimicrobial properties. Packaging materials comprising the shaped articles and other uses for the antimicrobial shaped articles and/or fabrics are also disclosed.

### CROSS REFERENCE TO RELATED APPLICATIONS

This application is a continuation of U.S. patent application Ser. No. 11/640,613, filed Dec. 18, 2006, which is incorporated by reference herein, which claims priority under 35 U.S.C. §120 to U.S. Provisional Application No. 60/750,889, filed Dec. 16, 2005, which is incorporated herein by reference in its entirety.

This invention relates to shaped articles including containers and closures, tubing, and films or sheets comprising ionomers that have been impregnated with antimicrobial ions, to objects, packaging materials and apparel comprising the shaped articles, and to fabrics comprising ionomers that have been impregnated with antimicrobial ions and objects such as apparel, wipes and filters prepared from the fabrics.

### BACKGROUND OF THE INVENTION

A variety of inorganic antimicrobial additives have been developed for the plastics and fibers industries. Addition of these agents can inhibit growth of mold, mildew, disease or odor-causing bacteria, such as Pseudomonas aerginsa, Staphylococus aereus, and Klebsiella pneumoniae. Commercial antimicrobial additives containing silver or copper (e.g., zeolites dispersed in polyethylene or polyester carriers) are available for use in a variety of plastics and fiber applications. Typically, these antimicrobial additives are distributed throughout the bulk polymer. Metal particles have also been mixed into polymers or applied to polymers. Processing polymers with such additives may be difficult and the mechanical properties of the shaped article may be affected.

Neutralized ethylene/(meth)acrylic acid copolymers, known as ionomers, have unique properties because of the intrinsic characteristics of the (meth)acrylic acid units and the neutralized carboxylate anion/cation pairs. Interactions between ion pairs, coupled with the nonpolar nature of the backbone, cause the ions to aggregate together forming thermally reversible, nanometer-scale dispersions of crosslinks. Ionomers, such as Surlyn® from E. I. du Pont de Nemours and Company, Wilmington, Del. (DuPont), can be used to make films and articles having properties such as improved melt strength, toughness, clarity, and adhesion resulting from the carboxylic acid salt crosslinks. Typically the ionomers comprise lithium, sodium, potassium, magnesium or zinc cations. See, e.g., Japanese Patent Application JP03039363 (preparing ionomers by neutralization of acid copolymers with copper or silver salts by melt kneading at elevated temperatures to distribute the metal ions throughout the resin and then converted to films). See also, Roy M. Broughton, Jr. and David M. Hall, Ionomer Studies of Polyethylene Acrylic Acid Copolymer. I. Fiber Preparation and Properties, Journal of Applied Polymer Science, 1993, 48, 9, 1501-1513 (treating fibers comprising an ethylene acrylic acid copolymer with aqueous sodium hydroxide, followed by treatment with various metal salts including copper and silver salts).

However, melt kneading requires the storage and handling of adequate quantities of base to effect neutralization of the bulk polymer. All processing equipment from neutralization through resin packaging is exposed to, and possibly contaminated by, the bases. This process also requires that the resulting antimicrobial ionomers be melt processible so that the resin can be extruded, packaged and further shaped into useful articles such as shaped articles, films, fibers and fabrics.

Because bacteria are exposed only to the surface of an article such as a film, antimicrobial ions in the interior of the bulk polymer, produced by melt kneading (distributing antimicrobial ions throughout the bulk polymer) are not available to exhibit their antibacterial properties—the thicker the article, the more difficulty occurs. Articles made from polymers with random distribution of antimicrobial ions, therefore, require relatively high amounts of the ions to be effective.

Articles having surfaces enriched with antibacterial ions may be expected to have better antimicrobial performance than articles with the same amount of antibacterial ions randomly distributed throughout the resin. Surface coatings containing antimicrobial ions such as copper or silver have been applied to polymers. However, it can be difficult to obtain proper adherence of the coating to the polymer because of poor affinity between the metal and the polymer. Coatings may also have significantly different mechanical properties than the polymer, leading to failure of the interface between the coating and the polymer. Abrasion of the surface coating may also occur.

Accordingly, it is desirable to prepare articles in which antibacterial ions are substantially concentrated at or near the surface, but are more intimately bound to the polymer as in ionomers. Such articles would provide more effective antibacterial control using less copper or silver than prior articles. The articles prepared in this manner can exhibit antibacterial activity for a variety of applications including packaging, health care, construction, surfaces, wipes, apparel, and packaging.

### SUMMARY OF THE INVENTION

The invention includes an article comprising or produced from at least one E/X/Y copolymer wherein the article includes a shaped article, fabric, or combinations thereof; the shaped article comprises a molded article including container, closure of the container, a profile extruded article (including tubing, film or sheet, or combinations of two or more thereof), or combinations of two or more thereof; the fabric comprises fibers and includes textile fabric, nonwoven fabric, or combinations thereof; E is ethylene; X is a C₃ to C₈ α,β-ethylenically unsaturated carboxylic acid; Y is a softening comonomer including alkyl acrylate, alkyl methacrylate, or combinations thereof; the alkyl group has one to eight carbon atoms; X is from about 2 to 30 weight % and Y is from 0 to about 40 weight % of the E/X/Y copolymer; the acid component (X) is at least partially neutralized to the carboxylate salt form; and the surface or at least a portion of the surface of the article is enriched (as compared to the interior of the shaped article or fiber) in copper cations, silver cations, or combinations thereof.

Of note are articles or fabrics wherein Y is 0 weight % of the E/X/Y copolymer. Also of note are articles or fabrics wherein Y is from about 1 to about 40 weight % of the E/X/Y copolymer.

The invention also includes a process, which can be used for preparing an article disclosed above, comprising contacting the surface or a portion thereof of an article with deionized water, or aqueous sodium hydroxide (caustic), at about 30 to about 60° C. to produce a treated article; contacting the treated article with a solution comprising copper salt, silver salt, or combinations thereof to produce a salt-treated article; optionally removing or purifying the salt-treated article; and optionally recovering the salt-treated article wherein the article can be the same as that disclosed above.

The invention further includes an object, packaging material or apparel comprising a shaped article as defined above; an article of clothing, protective apparel, wipe, drape, bandage, building furnishing, or filter comprising a fabric as defined above; or combinations of two or more thereof.

### DETAILED DESCRIPTION OF THE INVENTION

Shaped articles (for example, molded articles, tubing, film, or sheets) and fabrics (for example textiles or nonwovens) comprising ionomers can have their surfaces enriched with copper or silver ions.

Ethylene acid copolymers or ionomers thereof useful are available from DuPont such as Nucrel® and Surlyn®.

Various additives can be present in the polymer compositions including antioxidants and thermal stabilizers, ultraviolet (UV) light stabilizers, pigments and dyes, fillers, delustrants, anti-slip agents, plasticizers, other processing aids, or combinations of two or more thereof, and the like.

Shaped articles comprising acid copolymers or ionomers may be prepared from the molten polymeric material by a number of melt extrusion processes known in the art, such as injection molding, compression molding, blow molding, profile extrusion and the like.

Injection molded hollow articles suitable as bottle preforms are examples of molded articles of this invention. Examples of blow-molded articles include containers such as blown bottles. In the bottle and container industry, the blow molding of injection-molded preforms has gained wide acceptance.

Shaped articles may also be prepared by thermoforming processes, in which a thermoplastic film or sheet is heated above its softening temperature and formed into a desired shape. This formable sheet of a film or laminate is usually referred to as a forming web. Various systems and devices are used in a thermoforming process, often accompanied by vacuum-assist and plug-assist components to provide the proper forming of the forming web into a predetermined shape. Thermoforming processes and systems are well known in the art.

Thermoformed articles can have a shape in which a monolayer or multilayer sheet of material forms a concave surface such as a tray, cup, can, bucket, tub, box or bowl. The flat sheet can be heated (for example by a 315° C. black-body radiator) from above and below the sheet during a dwell time (for example for 30 to 40 seconds) during which time the surface temperature of the sheet will rise toward the nominal forming temperature of the sheet. At the end of the heat-cycle the sheet is immediately positioned over an unheated, optionally cooled cavity mold and clamped to the mold perimeter. Vacuum from within the mold during a short period (for example two seconds) draws the sheet into the mold. After a cooling period the thermoformed article is ejected from the mold. Alternatively, a plug may force the softened sheet into the cavity mold. Either method provides an article in which the sheet is stretched or drawn into a shape having a thinner cross-section and a greater surface area than the sheet had originally.

Thermoformed articles as described above are often used as containers for packaging various consumer goods subject to microbial contamination and spoilage.

Although containers are generally described herein as trays, cups, cans, buckets, tubs, boxes, bowls or bottles, other containers such as vials, jars, tubes, and the like may be prepared as described herein.

Article having its surface or at least portion thereof enriched with copper or silver ions can be produced by the process disclosed below.

The surface or at least a portion of the surface of the thermoformed or blow molded containers can be contacted with warm water or caustic for a period of time preferably sufficient to swell the article, followed by being contacted with a solution of copper or silver salts under a condition to enrich the surface or portion thereof with the metal ions. The condition includes ion exchange at ambient temperature or from about 0 to about 75° C. and atmospheric pressure. For example, the concave or inside portion of a container prepared from an ethylene acid copolymer or ionomer thereof may be filled with caustic at about 50° C. for a period of time to swell and prepare the inside surface for ion exchange. The caustic is then removed and a solution of copper or silver salts is placed in the container for a period of time. The original cations (for example, sodium) at the surface of the container are exchanged with the copper or silver cations from the solution, thereby providing a container with its inside surface enriched with copper or silver ions. Optionally, the container may be rinsed with deionized water after various steps such as after the caustic treatment and especially after the copper or silver treatment to wash away any ions that are not bound within the ionomeric matrix. This procedure is useful in preparing containers in which the antimicrobial copper or silver is selectively distributed at the surface of that portion of the container that will be in contact with the contents that need protection from microbial contamination.

Treatment of the shaped articles or fabrics by ion exchange as described herein can provide a means for concentrating the antimicrobial ions such as silver or copper at or near the surface of the article or fabric rather than throughout the bulk of the article or fabric as in prior art materials. Such treatment can provide more efficient use of the costly antimicrobial silver or copper ions, by the following attributes.

By creating the ionomer in situ, the antimicrobial ions can be uniformly and durably dispersed at the surface, where they are most effective. Bulky articles such as injection-molded pieces can be made highly antibacterial using minimal amounts of ions.

An effective surface layer can be formed in situ to perform the same function as a multilayer structure or laminate comprising a layer of copper or silver ionomer without the need for a complicated molding process. The “thickness” of the active layer can be adjusted by manipulating exchange conditions (such as pretreatment, concentration of ions, time and/or temperature of treatment).

A desired shaped article or fabric can be prepared by preforming the shaped article or fabric and then treating it to obtain antimicrobial activity. Preforming the article or fabric from ionomers can contribute to good processibility, thereby eliminating the need for preparing the antimicrobial surface layer itself to be melt-processible. The level of neutralization with antimicrobial ions can be tailored to whatever best provides antimicrobial activity without concern about processing parameters for molding or other shaping operations or fiber-forming operations.

Ion exchange does not require polymer solvents. The exchange can be carried out in aqueous media and is operationally simple.

Molded articles, such as containers and closures, and films are useful for packaging goods such as foodstuffs, cosmetics, health and personal care products, pharmaceutical products and the like that are subject to damage from mold, mildew, disease or odor-causing bacteria. Antimicrobial fabrics can be used for clothing, protective apparel, wipes, drapes, bandages, building furnishings, and industrial applications such as filters to prevent contamination by disease, odor-causing or otherwise noxious bacteria. Tubing can be used in packaging, storage and transfer of consumable fluids, for example beverages, and in medical applications, for example in packaging, storage and transfer of solutions for intravenous treatment.

Because blow-molding preforms have concave surfaces, the preforms may be treated as described above prior to blow molding the finished bottle.

Other examples of molded articles include injection molded or compression molded caps or closures for containers.

The bottles or containers of this invention are also useful for packaging liquids such as water, milk, and other dairy products, carbonated or non-carbonated beverages, and the like, or wines or spirits (e.g. gin or whiskey). They may also contain medicines or pharmaceuticals. They may be used to contain foods. Other liquids that may be packaged in bottles of this invention include edible oils, syrups, sauces, and purees such as baby foods. Powders, granules and other flowable solids may also be packaged in bottles of this invention.

A variety of containers are used to package consumer goods subject to microbial contamination. Most containers have closures or caps to adequately seal the contents of a container against leakage from or into the container. In many instances, the cap is designed for repeated removal and replacement as the consumer accesses the contents of the container. Caps comprising antimicrobial ionomers prepared as described herein are particularly useful for retarding spoilage of the contents of containers subject to repetitive openings.

Closures or caps for such containers are often prepared from thermoplastic compositions by injection molding or compression molding. A cap may consist of a top and a depending skirt that close around the neck of the container. In some instances caps may comprise continuous or discontinuous threads that provide screw closures to the container and/or snap closures. They may also incorporate dispensing features, tamper-evidence features and child resistant features. Other decorative or functional features may also be present. They may also include combinations with other materials (e.g., caps having metal lid portions or portions utilizing plastic materials other than an ionomer).

Linerless caps may be molded of an ethylene acid copolymer or ionomer thereof and then treated according to this invention to provide a cap with antimicrobial properties. The cap may be treated according to this invention by immersion in caustic followed by immersion in a copper or silver solution. In this manner, the cap is provided with antimicrobial properties over its entire surface. Caps may also be treated by filling the concave portion with the caustic and copper or silver solutions as described above for containers. In this manner caps are prepared with antimicrobial properties only on their inside surfaces that come in contact with the contents of the container.

Alternatively, caps may have a separate antimicrobial liner prepared according to this invention that is inserted into the shell of the cap. A liner comprising an ethylene acid copolymer or ionomer thereof may be compression molded into the shell of the cap and then treated according to this invention to provide a cap with antimicrobial properties.

Other closures of this invention include plastic stoppers or “corks” that are inserted into the opening of a container such as a wine bottle or perfume bottle. Stoppers may be treated according to this invention by immersing the stoppers either partially or fully in the caustic and copper or silver solutions to provide antimicrobial stoppers. Partial immersion provides a stopper with antimicrobial ions distributed on some portion of its surface and not on another portion.

Shaped articles may also be prepared by overmolding, in which an ethylene acid copolymer or ionomer thereof is molded over or around at least a portion of a substrate, such as a metal or plastic piece. The substrate is placed within the mold tooling of an injection-molding machine. The mold tooling when closed defines a cavity sized to receive the substrate in preparation for overmolding with the injection molding material. The interior walls of the mold tooling define the shape of the final overmolded piece. The mold tooling typically includes inwardly projecting pins, which serve to position and secure the substrate within the tooling during the injection process. The pins can be retracted by pressure response pin retractors into the mold tooling near the end of the injection cycle. A sprue through which the injection molding material is injected is also present in the mold tooling.

When the heated and plasticized molding material is injected under pressure by the injection molding machine, the plasticized molding material flows in through the sprue and fills the cavity. When the mold cavity is completely filled, the internal pressure within the cavity increases. The pins that position the substrate within the cavity are connected to pressure sensitive pin retractors. When the pressure in the mold cavity reaches a predetermined level, the pins retract into the mold cavity wall, and the molding material fills the space vacated by the pins. Upon completion of the overmolding process, the mold tooling is opened and the completed shaped article is ejected.

The resulting article has a casing of ethylene acid copolymer or ionomer thereof over at least a portion of the substrate. The overmolded casings may have a wall thickness of between about 0.005 inches to over one inch, depending on the desired exterior shape of the completed assembly and the shape of the substrate. The wall thickness of the casing may be uniform or may vary significantly at various locations about the substrate; however, for most applications the wall thickness will preferably be less than 0.5 inches.

The overmolded assembly is then treated sequentially with warm water or preferably caustic, followed by treatment with silver or copper solutions to provide a shaped article of this invention.

Another shaped article is a profile. Profiles are defined by having a particular shape and by their process of manufacture known as profile extrusion. Profiles are not film or sheeting, and thus the process for making profiles does not include the use of calendering or chill rolls. Profiles are also not prepared by injection molding processes. Profiles are fabricated by melt extrusion processes that begin by extruding a thermoplastic melt through an orifice of a die forming an extrudate capable of maintaining a desired shape. The extrudate is typically drawn into its final dimensions while maintaining the desired shape and then quenched in air or a water bath to set the shape, thereby producing a profile. In the formation of simple profiles, the extrudate preferably maintains shape without any structural assistance. With extremely complex shapes, support means are often used to assist in shape retention.

A common shape of a profile is tubing. Tubing assemblies for the transport of liquids and vapors are well known in the art. The tubing is in nearly constant contact with fluids and additives. Tubing is used for fluid transfer in medical applications or in transferring fluids such as beverages. The inside surface of tubing comprising an ethylene acid copolymer or an ionomer thereof can be treated according to this invention to prepare tubing with antimicrobial properties for the transfer of fluids that are subject to microbial contamination. For example, caustic at about 50° C. may be passed through the tubing prepared from an ethylene acid copolymer or ionomer thereof for a period of time to swell and prepare the inside surface for ion exchange. Then a solution of copper or silver salts is passed through the tubing for a period of time. The original cations (for example, sodium) at the inside surface of the tubing are exchanged with the copper or silver cations from the solution, thereby providing tubing with its inside surface enriched with copper or silver ions. Optionally, the tubing may be rinsed with deionized water after various steps such as after the caustic treatment and especially after the copper or silver treatment to wash away any ions that are not bound within the ionomeric matrix. This procedure is useful in preparing tubing in which the antimicrobial copper or silver is selectively distributed at the inside surface that will be in contact with the fluid that needs protection from microbial contamination.

Films useful in this invention can be prepared as monolayer or multilayer films, provided at least one surface of the film comprises an ethylene acid copolymer or ionomer thereof that can be treated according to this invention to provide an antimicrobial film. Sheets are similar to films; as used herein, sheets are considered to be thicker than films. Although the following description refers to films, the description also applies to sheets. The films can be prepared by (co)extrusion to make cast or blown films according to well known procedures. Multilayer film structures may also be prepared by lamination or extrusion coating.

A laminate film useful in the present invention can be further oriented beyond the immediate quenching or casting of the film. The process comprises the steps of coextruding a multilayer laminar flow of molten polymers, quenching the coextrudate and orienting the quenched coextrudate in at least one direction.

Films of this invention can be prepared by treating at least a portion of the surface of the film with caustic followed by treatment with solutions of copper or silver salts. The film can be treated by total immersion in the caustic and copper or silver solutions or by exposing only one face of the film to the caustic and copper or silver solutions. Multilayer films having one face layer of ethylene acid copolymer or ionomer thereof can be treated according to this invention to provide films with one face having antimicrobial properties.

The film may also be laminated to a substrate such as foil, paper, paperboard or nonwoven fibrous material to provide a packaging material of this invention. Preferably, the film is laminated to the substrate so that a face having antimicrobial properties remains as a face layer on the packaging material. The packaging material may also be processed further by, for example but not limitation, printing, embossing, and/or coloring to provide a packaging material to provide information to the consumer about the product therein and/or to provide a pleasing appearance of the package.

The films and laminate structures can be used in a wide variety of packaging for consumer goods vulnerable to microbial contamination. They can be used as wraps, package liners, package inserts, lidding and tapes. They can be formed into bags, pouches and other fabricated structures.

Fabrics can be prepared from fibers treated according to procedures described herein. Fibers comprising ethylene acid copolymers can be prepared by conventional fiber-forming processes such as melt spinning. Said fibers are treated with copper or silver salts solutions as described above to provide fibers in which the surface is enriched in copper or silver ions relative to the interior of the fiber. The fibers can be woven, knitted or otherwise interlaced, or bonded to provide fabrics of this invention. Alternatively, fabrics can be prepared and then treated according to procedures described herein. Said fabrics can be prepared by traditional textile processes, including weaving or knitting or by nonwoven processes, including spunbonding (S), meltblowing (M), hydroentangling, needling, thermal bonding or chemical bonding. Fabrics comprise one or more layers of filamentary or plexifilamentary structures, including SMS, SMMS, SMMMS multi-layer fabric constructions and the like.

Items such as foods and drinks, health and personal care products, cosmetics, pharmaceuticals, medicines, clothes, shoes, furniture, office equipment, stationary, printed matter, daily-use goods, optical equipment, tools, tableware, accessories, toys, playing tools, exercise tools, livestock, and pets may be packaged, protected and/or transported using shaped articles or fabrics of this invention. These contents are packaged in or contacted with the packaging material of various shapes and/or forms in accordance with the purposes to prevent the proliferation of bacteria, and the contents can be stored and used in a clean and hygienic state.

In addition to use as packaging materials, the shaped articles or fabrics of this invention can be used in a wide variety of applications where antimicrobial properties are desired.

For example without limitation, the materials may be used in medical, food preparation and storage, clothing and apparel, construction and industrial applications.

Shaped articles used in medical and health care applications include devices such as cannulae, stents, catheters, medical implants, wound closure devices such as sutures, devices for purifying or sterilizing aqueous solutions or gases, devices for storing, transporting or dispensing sterile solutions, devices for controlling odors, dental devices, toothbrushes and other dental equipment. Films and fabrics may be used in wound dressings, bandages, garments such as gowns and masks, and surgical drapes.

Food preparation and storage applications include shaped articles such as cutting boards, bowls, dishes, drinking glasses, cooking and eating utensils, vacuum bottles, parts or linings for refrigerators, dishwashers, rice cookers, can openers, juicers, and the like. Fabrics and films can be used as conveyor belts used in food processing plants, coverings, drapes or liners for food preparation areas, and liners of display cabinets and coolers, particularly for food display and storage, napkins, tablecloths and placemats. Fabrics and films can also be used for cleaning and sanitizing wipes.

Clothing and apparel applications include protective apparel, sportswear, intimate apparel, shoes and shoe linings, socks, undergarments, hats, helmets, watch bands and the like, and home or institutional bedding.

Household and personal items according to this invention include hair setting and styling utensils, combs and other personal care utensils, eyeglasses, telephones, computer mouse units and mouse pads, keypads, writing utensils, calculators, cameras, pails, garbage containers, game boards and pieces, toys, credit cards, books, linings of purses, wallets and card cases, umbrella handles, flower pots and furniture.

Construction and building furnishing applications include films, sheets and fabrics used for wallcoverings, floor coverings such as carpets and carpet backings, flooring tiles or sheets, floor mats, swimming pool walls, and other surfaces. Other building furnishings include linings or drapes for lockers, stables, barns, medical treatment rooms, shelf and drawer liners, shower curtains, floor mats and the like. Tabletops, counters and other surfaces may be fabricated with an antimicrobial surface layer prepared according to this invention. Shaped articles may be used for construction materials such as composite lumber. Other shaped articles include fittings for contamination-prone areas such as restroom facilities, locker rooms and the like including toilet seats, toilet bowls, bathtubs and shower areas, sinks, soap dishes, and associated parts, and door handles and other hardware.

Industrial applications of shaped articles of this invention include machine and vehicle parts that come into contact with hands such as steering wheels, handles, knobs and the like, surfaces subject to immersion in nonsterile environments including the surface of boat hulls, fish nets, and protective equipment including breathing masks, filters and the like.

While the invention has been particularly shown and described with reference to the preferred embodiments thereof, various changes in form and details may be made without departing from the spirit and scope of the invention.

The following Examples are merely illustrative, and are not to be construed as limiting the scope of the invention.

### Examples

Films comprising a variety of mixed ion ionomers enriched with silver at the surface were made by ion exchange. Films comprising ethylene/methacrylic acid (MAA) copolymers partially neutralized with sodium (sodium ionomers) were preconditioned by swelling in a warm caustic solution or water and then placed into solutions of silver nitrate for varying lengths of time to effect ion exchange. After exposure, films were removed from the silver nitrate solution and rinsed three times in deionized water to remove unbound silver salts, dried in air, and tested for ion content by Inductively Coupled Plasma Spectroscopy (ICP) and antimicrobial activity in shake flask tests. The silver-containing films were found to be effective antimicrobial agents. Films having silver ion content as low as 100 ppm were efficacious against gram-positive and gram-negative bacteria.

Films, about 2 mils in thickness, consisting of the sodium ionomers indicated in Table 1 were conditioned for ion exchange by soaking in a warm (55° C.) sodium hydroxide solution (0.5 N) for three hours. Samples were then removed from the sodium hydroxide solution and placed into an aqueous silver nitrate solution (5 g/L) for 18 hours. Exchanged films were rinsed three times in deionized water and allowed to air dry. Comparison films were treated by exposure to the sodium hydroxide solution followed by a deionized water rinse and then dried in air. A film prepared from low density polyethylene was treated similarly to provide Comparative Example C5.

In the Tables, “Precursor Film” refers to a film prior to any treatment. “Pre-exchange” refer to comparison films rinsed after caustic treatment only (not ion exchanged). “Post-exchange” refers to films after caustic treatment and ion exchange with silver nitrate. Such post-exchange films are examples of articles of this invention. ICP data in Table 2 were converted to ion exchange efficiencies and are summarized in Table 3a and Table 3b.

TABLE 1

| | Methacrylic | Nominal | Nominal | Measured | Measured |
|---|---|---|---|---|---|
| | acid | Na | Na | Na | Na |
| | wt % | wt % | mg/kg | mmole/kg | weight % |
| Precursor | 10 | 1.47 | 14700 | 632 | 1.45 |
| Film 1 | | | | | |
| Precursor | 15 | 1.07 | 10700 | 500 | 1.15 |
| Film 2 | | | | | |
| Precursor | 15 | 2.25 | 22500 | 1017 | 2.34 |
| Film 3 | | | | | |
| Precursor | 10 | 0.9 | 9000 | 402 | 0.93 |
| Film 4 | | | | | |
| Precursor | 0 | 0 | 0 | 0 | 0 |
| Film C5 | | | | | |

TABLE 2

| | | Na mg/kg | | Ag mg/kg | |
|---|---|---|---|---|---|
| | | Pre- | Post- | Pre- | Post- |
| Example | Film* | Exchange | Exchange | Exchange | Exchange |
| 1 | Precursor | 20570 | 17390 | 12 | 10795 |
| | Film 1 | | | | |
| 2 | Precursor | 33700 | 17610 | 29 | 48920 |
| | Film 2 | | | | |
| 3 | Precursor | 33950 | 18310 | 70 | 31270 |
| | Film 3 | | | | |
| 4 | Precursor | 22425 | 17005 | 47 | 17525 |
| | Film 4 | | | | |
| C5 | Precursor | 265 | 14 | 34 | 12 |
| | Film C5 | | | | |

*Low levels of ions other than sodium and silver were detected (by ICP) in films prior to treatment

TABLE 3a
After Aqueous NaOH treatment

| Film | Na (mg/kg) | Na (mmole/kg) | % Neutralized |
|---|---|---|---|
| Pre-exchange 1 | 20570 | 894 | 78% |
| Pre-exchange 2 | 33700 | 1465 | 85% |
| Pre-exchange 3 | 33950 | 1476 | 86% |
| Pre-exchange 4 | 22425 | 975 | 85% |
| Pre-exchange C5 | 265 | 12 | — |

TABLE 3b
After Ion Exchange

| | | | | | % | |
|---|---|---|---|---|---|---|
| | Na | Na | Ag | Ag | Neutralized | Total % |
| Example | mg/kg | mmole/kg | mg/kg | mmole/kg | with Silver | Neutralized |
| 1 | 17390 | 756 | 10795 | 100 | 9% | 74% |
| 2 | 17610 | 766 | 48920 | 453 | 26% | 71% |
| 3 | 18310 | 796 | 31270 | 290 | 17% | 63% |
| 4 | 17005 | 739 | 17525 | 162 | 14% | 78% |
| C5 | 14 | 1 | 12 | 0 | — | — |

Aqueous caustic exposure increased the degree of neutralization to 78 to 86%, depending on the initial resin. After exposure to silver nitrate, the degree of neutralization by silver ranged from 9% to 26% while the total degree of neutralization (by sodium and silver) ranged from 63% to 78%. Comparative Example C5, without ionizable moieties, was expected to be unable to absorb silver, but adventitious amounts of sodium and silver were detected by ICP.

Immobilized and slowly diffusing antimicrobial agents did not diffuse into their environment at an efficacious rate under normal conditions of use or testing. Therefore, test methods such as AATCC (American Association of Textile Chemists and Colorists)-90-1982 (Antibacterial Activity of Fabrics, Detection of: Agar Plate Method, Technical Manual of the AATCC, Vol. 58, p. 298-299) and AATCC-147-1982 (Antibacterial Activity of Fabrics, Detection of: Parallel Streak Method, Technical Manual of the AATCC, Vol. 58, p. 300-301) which directly depended on the rapid rate of leaching of the antimicrobial agent from the treated substance were inappropriate. The following method, having the advantage over other methods of ensuring good contact between the microorganisms and the treated substance was used (accomplished by constant agitation of the test specimen in a buffer during the test period).

Duplicate control and test samples were evaluated to determine the variability in testing. The test bacteria were Klebsiella pneumoniae (ATCC No. 4352) and Staphylococcus aureus (ATCC No. 6538). The bacteria were suspended in 2.5 ml of phosphate buffer and shaken at room temperature for 24 hours with 25 mg of sample (VWR orbital shaker). Dacron® fibers containing the antimicrobial agent DC5700 were used in the assay as a positive control.

Enumerations were performed by plating on Trypticase® Soy Agar (TSA, Northeast Laboratories) plates. Plates were incubated overnight at 37° C. to allow for the development of colonies. The colony counts were reported as the number of Colony Forming Units (CFU) per ml.

Whether a sample having significant antimicrobial activity in the shake flask test was demonstrated at least 3 log reduction when compared to the inoculated control. The level of antimicrobial activity is expressed as the Δt value where

Δt=log CFU/ml of the Inoculated Control−log CFU/ml of the Test Sample (Both at the same exposure time)

Shake flask test results are summarized in Table 4, which indicates that all the silver-containing ionomers were as efficacious as a known DC5700-treated Dacron® antimicrobial fiber against both K. pneumoniae and S. aureus bacteria. In contrast, samples of polyethylene that had been processed under identical ion exchange conditions (05) showed no efficacy (0.1 log increase of K. pneumoniae and 0.2 log reduction of S. aureus) vs. inoculated controls. These results demonstrated that films comprising antimicrobial ionomers were antimicrobial.

TABLE 4

| | After Ion Exchange | | Shake Flask Results | |
|---|---|---|---|---|
| | Measured | | S. aureus | K. pneumoniae |
| Example | Na weight % | Ag weight % | 24 hr log kill | 24 hr log kill |
| 1 | 1.74 | 1.08 | 3.8 | 4.3 |
| 2 | 1.76 | 4.89 | 3.8 | 4.3 |
| 3 | 1.83 | 3.13 | 3.8 | 4.3 |
| 4 | 1.70 | 1.75 | 3.8 | 4.3 |
| C5 | 0.00 | 0.00 | 0.2 | −0.1 |

| | | |
|---|---|---|
| DC5700-Treated Dacron ® Control | 3.8 | 4.3 |

To determine whether lesser amounts of silver could provide adequate antimicrobial functionality, additional sets of samples were prepared using Precursor Film 1 as the starting material. Experimental mixed ion ionomers, which varied in silver content, were made by (a) preswelling in deionized water or 0.5N NaOH solution followed by (b) exposing swollen samples to 0.5 g/l AgNO₃ solution for varying lengths of time ranging from 0 (no exposure) to 18 hours.

ICP results, shown in Table 5, indicated that pretreatment in NaOH dramatically increased sodium content from 14,500 ppm in the Precursor Film 1 to 22,900 ppm (Sample C6), while pretreatment in deionized water actually leached sodium from the sample and reduced sodium content from 14,500 ppm to 11,700 ppm (Sample C10). The silver content increased and the sodium content decreased with time as ions were exchanged in an AgNO₃ solution. Pretreatment conditions showed effect on the amount of silver exchanged. Samples swollen in the NaOH solution absorbed from 14,300 ppm Ag (1.5 hours exposure to AgNO₃) to 32,000 ppm Ag (18 hours exposure). Corresponding samples swollen in deionized water absorbed less than 300 ppm Ag after 18 hours exposure to AgNO₃. Samples C6 and C10, which had been pretreated but not exposed to AgNO₃, appeared contaminated during processing or testing, picking up adventitious amounts of silver (12 and 60 ppm, respectively).

TABLE 5

| Pretreatment | NaOH, 55° C., 3 h | | | Deionized water 55° C., 3 h | | |
|---|---|---|---|---|---|---|
| Ion Exchange | | Ag | Na | | Ag | Na |
| Time (h) | Example | (ppm) | (ppm) | Example | (ppm) | (ppm) |
| 0 | C6 | 12 | 22900 | C10 | 60 | 11700 |
| 1.5 | 7 | 14300 | 19400 | 11 | 105 | 12100 |
| 5.5 | 8 | 26800 | 18000 | 12 | 125 | 12300 |
| 18 | 9 | 32200 | 17200 | 13 | 280 | 11000 |

Shake flask test results are summarized in Table 6. All samples that had undergone ion exchange in an AgNO₃ solution were found to be effective in destroying Gram-negative (K. pneumoniae) and Gram-positive (S. aureus) bacteria. Even sample 11, which had been pretreated in deionized water and exposed to AgNO₃ for 90 minutes, had silver content of only about 100 ppm but was completely effective in destroying bacteria within 24 hours.

Samples C6 and C10, which had not been exposed to ion exchange solutions, were found to contain small amounts of silver according to ICP analysis. Sample C6, which had been swollen in an aqueous caustic but not exposed to AgNO₃, showed no gram-positive antimicrobial activity but was highly effective against gram-negative bacteria. Sample C6 was retested because of its surprising effectiveness against gram negative K. pneumoniae bacteria. In the retest, E. coli was used as the gram negative bacteria while S. aureus was again used as the gram positive bacteria. Gram-negative bacteria are extremely sensitive to base; therefore, the effectiveness of sample C6 against gram negative bacteria may have been due to traces of NaOH that had not been completely rinsed out of the sample. Sample C10 (despite its apparent Ag content of 60 ppm) was completely ineffective against both types of bacteria.

TABLE 6

| | |
|---|---|
| Gram Negative* | Gram Positive |

| | | | |
|---|---|---|---|
| Example | K. pneumoniae | E. coli | S. aureus |

| | | | | |
|---|---|---|---|---|
| C6 | 4.4 | 4.5 | 0.5 | −0.1 (retest) |
| 7 | 5 | | 4.1 | |
| 8 | 5 | | 4.1 | |
| 9 | 5 | | 4.1 | |
| C10 | 0.2 | | 0.2 | |
| 11 | 5 | | 4.1 | |
| 12 | 5 | | 4.1 | |
| 13 | 5 | | 4.1 | |

*Sensitive to NaOH

1. An article comprising or produced from at least one E/X/Y copolymer wherein
the article includes a shaped article, fabric, or combinations thereof;
the shaped article includes a molded article including container, closure of the container, a profile extruded article (including tubing, film or sheet, or combinations of two or more thereof), or combinations of two or more thereof;
the fabric comprises fibers and includes textile fabric, nonwoven fabric, or combinations thereof;
E is ethylene;
X is a C₃ to C₈ α,β-ethylenically unsaturated carboxylic acid and is present in the copolymer from about 2 to 30 weight %;
Y is a comonomer including alkyl acrylate, alkyl methacrylate, or combinations thereof; the alkyl group has one to eight carbon atoms; and Y is present in the copolymer from 0 to about 40 weight %;
the acid component (X) is at least partially neutralized to the carboxylate salt form; and
the surface or at least a portion of the surface of the article is enriched (as compared to the interior of the shaped article or fiber) in copper cations, silver cations, or combinations thereof.

2. The article of claim 1 wherein the article is produced from the copolymer; and Y is about 1 to about 40 weight % of the copolymer.

3. The article of claim 1 wherein the article is produced from the copolymer by melt processes; the article is the shaped article; and the surface or at least a portion of the surface of the article is enriched with copper cations.

4. The article of claim 2 wherein the article is the shaped article and the surface or at least a portion of the surface of the article is enriched with silver cations.

5. The article of claim 1 wherein the article is produced from the copolymer by melt processes; the article is the fabric; and the surface or at least a portion of the surface of the article is enriched with copper cations.

6. The article of claim 2 wherein the article is the fabric and the surface or at least a portion of the surface of the article is enriched with copper cations.

7. The article of claim 3 wherein the article is clothing, protective apparel, wipe, drape, bandage, building furnishing, or filter.

8. The article of claim 4 wherein the article is clothing, protective apparel, wipe, drape, bandage, building furnishing, or filter.

9. The article of claim 6 wherein the article is clothing, protective apparel, wipe, drape, bandage, building furnishing, or filter.

10. The article of claim 3 wherein the article is a packaging material or apparel.

13. A process comprising
providing an article comprising or produced from an ethylene acid copolymer or an ionomer of the acid copolymer; the acid copolymer comprises repeat units derived from ethylene, C₃ to C₈ α,β-ethylenically unsaturated carboxylic acid, and optionally a comonomer; the comonomer includes alkyl acrylate, alkyl methacrylate, or combinations thereof;
contacting the surface or a portion thereof of an article with deionized water, or aqueous sodium hydroxide, at about 30 to about 60° C. to produce a treated article;
contacting the treated article with a solution comprising copper salt, silver salt, or combinations thereof to produce a salt-treated article;
optionally purifying the salt-treated article including shaped article, fabric, or combinations thereof; and
optionally recovering the salt-treated article.

14. The process of claim 13 wherein the repeat units derived from the C₃ to C₈ α,β-ethylenically unsaturated carboxylic acid is about 1 to about 40 weight % of the copolymer.

15. The process of claim 13 wherein the article is the shaped article and the surface or at least a portion of the surface of the article is enriched with copper cations.

16. The process of claim 14 wherein the article is the shaped article and the surface or at least a portion of the surface of the article is enriched with copper cations.

17. The process of claim 13 wherein the article is the fabric and the surface or at least a portion of the surface of the article is enriched with copper cations.

18. The process of claim 14 wherein the article is the fabric and the surface or at least a portion of the surface of the article is enriched with copper cations.

19. The process of claim 14 wherein the article is clothing, protective apparel, wipe, drape, bandage, building furnishing, or filter.

20. The process of claim 14 wherein the article is packaging material or apparel.

21. The process of claim 14 wherein the article is a film; the treated article is contacted in a silver nitrate solution to produce a silver ion-containing film; and the film comprises an ethylene methacrylic acid copolymer partially neutralized with sodium.

22. The process of claim 19 wherein the degree of neutralization of the acid copolymer partially neutralized with sodium has a lower degree of neutralization than that of the treated article.
